(19) United States
(12) Patent Application Publication
(10) Pub. No.: US 2005/0235136 A1
(43) Pub. Date: Oct. 20, 2005

(54) Methods and systems for thread monitoring

(75) Inventors: Laurene Janet Barsotti, Aurora, IL (US); Ying Dai, Naperville, IL (US); Stuart Michael Morton, Zionsville, IN (US); Sameer Dattatrey Prabhu, Naperville, IL (US)

Correspondence Address: DUFT BORNSEN & FISHMAN, LLP, 1526 SPRUCE STREET, SUITE 320, BOULDER, CO, 80302, US

(73) Assignee: Lucent Technologies Inc., Murray Hill, NJ (US)

(21) Appl. No.: 10/826,776

(22) Filed: Apr. 16, 2004

(51) Int. Cl. G06F 9/00

(52) U.S. Cl. 713/1

(57) ABSTRACT

Methods and systems to provide monitoring of operation of threads of a multi-threaded process. In one aspect a reusable thread monitor class is provided that permits each thread desiring monitoring to register with a monitor supervisor. The monitor supervisor may be instantiated in a thread of the process and monitors the operable/inoperable status of the registered threads. The monitor supervisor may be instantiate in any thread of the multi-threaded process or in a specific thread spawned specifically for the monitor supervisor. In a preferred, best presently know mode of practicing the invention, the monitor supervisor is instantiated in the main thread of the process. Monitoring may include “IsAlive” thread status checks, HeartBeat signaling status checks, and/or Polling status check capabilities.

### BACKGROUND OF THE INVENTION

1. Field of the Invention

The invention relates generally to management of multi-threaded computing processes and more specifically relates to programming structures and methods for monitoring threads in a multi-threaded computing process.

2. Statement of the Problem

It is generally known in the computing arts that one or more processes may be provided to solve a particular computing problem. As used herein, “process” refers to a collection of related program instructions operable on one or more processors of a computing environment to achieve a particular desirable function on or in the computing environment. Multiple processes may also cooperate using inter-process communication techniques such that a larger application for a computing environment may be subdivided into multiple processes more easily distributed throughout the cluster or network of computing systems or processors.

A process generally performs a sequence of instructions in a particular, substantially sequential order to achieve the desired functionality. Where multiple processes are involved, the multiple processes may all cooperate by exchanging inter-process messages and signals to coordinate their respective activities. Though multiple processes may coordinate their activities through such inter-process communication techniques, each process, in essence, runs in its own private computing space (primary and secondary storage, object space, etc.) not generally accessible by another processes, hence the need for message and signal exchanges to coordinate the computing among multiple processes.

As an example of multiple processes that cooperate to perform a desired computing goal, consider the Microsoft Office suite of application programs. For example, Microsoft Word and Microsoft Excel are independent programs within the Microsoft Office suite. Programs or processes that collectively comprise Microsoft Word do not directly access the program and data space associated with Microsoft Excel running simultaneously or concurrently. Rather, inter-process messaging and signaling techniques are employed to exchange information between the two otherwise independent processes.

Such inter-process communication techniques may be cumbersome where related programming features are tightly integrated but yet do not lend themselves well to a single, sequential program execution sequence. For example, within Microsoft Word, numerous background processing methods may be operable as a user continues to enter new data into the Word document. Spell checking, grammar checking, automatic formatting, etc. are all examples of background processing that may be operable as a user of Microsoft Word enters new data. All these examples of background processing operate substantially concurrently with other user interaction. Such a collection of functions may most preferably be tightly coupled with one another—sharing data variables and other structures and objects. Well known inter-process communication among a plurality of processes implementing these tightly coupled function renders this level of cooperation more difficult.

It is also generally known that a single process may be further subdivided into multiple threads. As used herein, “thread” refers to program instructions that perform a portion of programming functionality within a single process. Multiple such threads may be operable substantially concurrently and associated with the same process space (i.e., may share access to data and object storage). Therefore, multiple threads may readily exchange information by sharing data space and objects not readily accessible through well-known inter-process communication techniques.

Following the above example, in Microsoft Word, a user interface thread may be substantially concurrently operable with a grammar checking thread which, in turn, is substantially, concurrently operable with a spell checking thread, a formatting thread, etc. Such a process may be referred to as a multi-threaded process or application.

In a computing environment it is common to provide a process monitor—frequently supplied as a feature of the operating system or as a part of system tuning or system debugging tools. Such a process monitor periodically verifies the state of each process running in a computing environment to verify it is still apparently healthy and operable. However, where a process includes multiple threads, it may be the case that one or more threads remain operable while one or more other threads are hung or otherwise inoperable. A process monitor typically monitors only a single thread of a process. Nothing in the presently known arts provides for monitoring of such multiple threads within a process to help detect a hung or inoperable thread. For example, a user of Microsoft Word may be able to enter new text into a document while, unbeknownst to the user, the background formatting, spell checking, grammar checking, etc. threads may be hung in some inoperable state. Detecting such a hung thread state would be desirable to permit graceful recovery from such a condition thereby reducing potential for data loss.

It is evident from the above discussion that a need exists for improved thread monitoring structures and methods to provide improved detection of dead or otherwise hung threads of a multi-threaded computing process.

### SUMMARY OF THE SOLUTION

The invention solves the above problems and other problems with methods and systems for thread monitoring. A reusable thread monitoring class is provided including a thread monitor supervisor operable within a thread of a multi-threaded process to monitor operable/inoperable status of other threads in the process. A thread that is to be monitored in a multi-threaded process instantiates an object of the thread monitoring class to utilize the features of the class. The supervisor is instantiated in a thread of the process as well. The reusable thread monitoring class may include methods to permit threads to register for monitoring by the monitor supervisor. Registration may include parameters indicating various types of monitoring that may be desired. Exemplary types of monitoring may include: “IsAlive”, “Polling” and “HeartBeat” as well as combinations of these and others. The monitor supervisor may be instantiated in any of the threads to be monitored and most preferably may be instantiated in a main thread of the multi-threaded process. Other methods of the reusable thread monitoring class permit unregistration of a previously registered thread to terminate monitoring thereof as well as a stop/disable monitoring method to disable monitoring of all registered threads. The thread monitoring class is reusable in that it is a self-contained, cohesive component that may be integrated into any application process. The thread monitoring class does not depend on features or functions of the multi-threaded process as may a customized thread monitoring capability. Rather the thread monitoring class features and aspects hereof may be reused and easily incorporated into any multi-threaded process that may benefit from thread monitoring.

An aspect hereof therefore provides a computing system providing multi-threaded programming support, the system comprising: a thread monitor class providing thread monitoring services to threads of a multi-threaded process, the thread monitor class including: a thread registration method to register a thread for monitoring by the class; and a thread monitoring supervisor to monitor all threads registered for monitoring operation of threads that invoke the thread registration method.

Other aspects hereof further provide that the thread monitor class further includes: a thread un-registration method to remove a prior registration of a thread for monitoring by the class.

Other aspects hereof further provide that the thread monitor class further includes: a stop thread monitoring method to terminate monitoring of all threads registered for monitoring by the class.

Other aspects hereof further provide that the thread monitor class further includes: a thread HeartBeat method to signal a HeartBeat from a thread registered for monitoring by the class.

Other aspects hereof further provide that the thread registration method comprises: a thread alive check registration method invoked by a thread to register for monitoring by the class wherein the monitoring comprises periodically verifying that the invoking thread is still alive.

Other aspects hereof further provide that the thread registration method comprises: a thread poll registration method invoked by a thread to register for monitoring by the class wherein the monitoring comprises periodically verifying that the invoking thread is properly operating by invoking a poll method derived from the thread poll registration invocation.

Other aspects hereof further provide that the thread registration method comprises: a thread HeartBeat registration method invoked by a thread to register for monitoring by the class wherein the monitoring comprises periodically verifying that the invoking thread is still alive based on receipt of periodic HeartBeat method invocations from the thread invoking the thread HeartBeat registration method.

Other aspects hereof further provide that the thread monitoring supervisor is instantiated within a main thread of a multi-threaded program.

Other aspects hereof further provide that the thread monitoring supervisor is further operable to restart an inoperable thread.

Other aspects hereof further provide that the thread monitoring supervisor is further operable to restart the process that includes an inoperable thread.

Another aspect hereof provides a method for monitoring operability of multiple threads of a computer process comprising the steps of: instantiating a thread monitoring supervisor in a thread of a multi-threaded process; registering an additional thread of the multi-threaded process for monitoring of its operation by the thread monitoring supervisor; and monitoring the operability of the additional thread by operation of the thread monitoring supervisor.

Other aspects hereof further provide that the step of registering further comprises registering the additional thread as a HeartBeat thread for monitoring according to HeartBeat signals, and that the additional thread is operable to periodically communicate a HeartBeat signal with the monitoring supervisor, and that the step of monitoring further comprises detecting periodic receipt of HeartBeat signals to monitor operability of said additional thread.

Other aspects hereof further provide that the step of monitoring further comprises determining whether said additional thread is still alive to monitor operability of said additional thread.

Other aspects here further provide that the step of registering further comprises registering the additional thread as a polling thread associated with a poll function to indicate the operability status of the additional thread, and that the step of monitoring further comprises periodically invoking the poll function associated with the additional thread to monitor operability of the additional thread.

Other aspects hereof further provide that the step of instantiating further comprises instantiating the thread monitoring supervisor in a main thread of the multi-threaded process.

Other aspects hereof further provide that restarting an inoperable thread.

Other aspects hereof further provide for restarting a process that includes an inoperable thread.

### BRIEF DESCRIPTION OF THE DRAWINGS

The same reference number represents the same element on all drawings.

FIG. 1 is a block diagram of an exemplary system embodying thread monitoring features and aspects hereof.

FIG. 2 is a flowchart describing operation of an exemplary thread monitor supervisor.

FIG. 3 is a flowchart describing operation of an exemplary registration method.

FIG. 4 is a flowchart describing operation of an exemplary unregistration method.

FIG. 5 is a flowchart describing operation of an exemplary stop monitoring method.

FIG. 6 is a flowchart describing operation of an exemplary thread registering for Polling monitoring features.

FIG. 7 is a flowchart describing operation of an exemplary thread registering for HeartBeat monitoring features.

FIG. 8 is a flowchart describing operation of an exemplary thread registering for “IsAlive” monitoring features.

### DETAILED DESCRIPTION

For the purpose of teaching inventive principles in the following discussion, some conventional aspects of the invention have been simplified or omitted. Those skilled in the art will appreciate variations from these embodiments that fall within the scope of the invention. Those skilled in the art will appreciate that the features and aspects described below can be combined in various ways to form multiple variations of the invention. As a result, the invention is not limited to the specific embodiments described below, but only by the claims the follow and their equivalents.

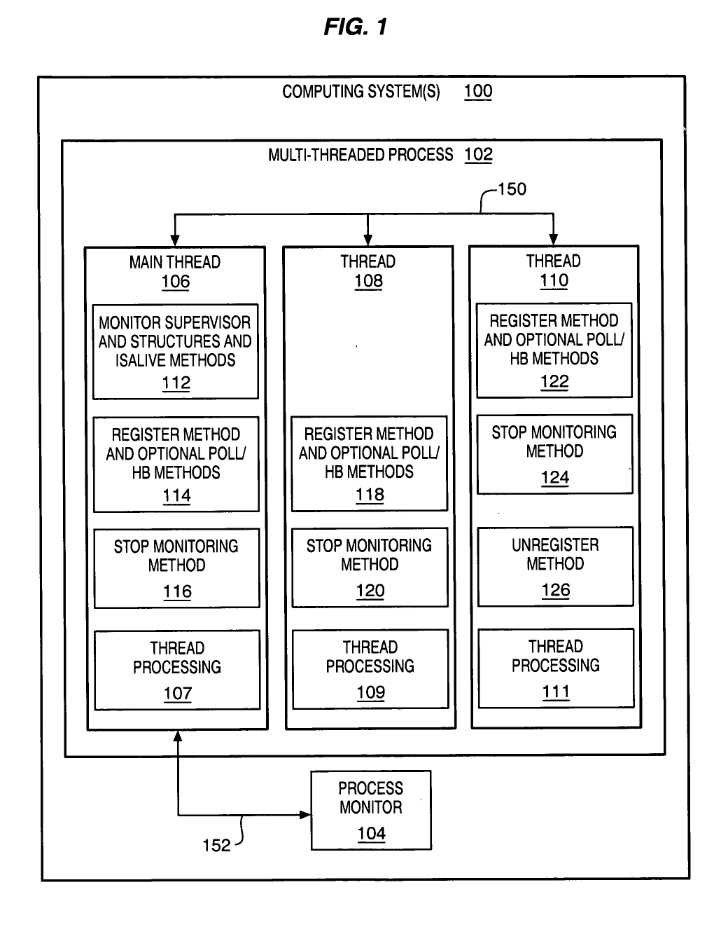

FIG. 1 is a block diagram of a computing system 100 in which a multi-threaded process 102 is operable. Multi-threaded process 102 may be monitored by a process monitor 104 via communication path 152. Such a process monitoring is well known in the art to provide administrative or expert users with information regarding a particular process 102. Such information may indicate, for example, that the process 102, as a whole, appears to be operating normally or is failing to respond to process monitor 104. As is generally known in the art, multi-threaded process 102 may be operable on a single computing system 100 or may be distributed through a network or cluster of tightly coupled computing systems or processors. Such distributed computing paradigms and the distribution of a multi-threaded process 102 over such a plurality of computing systems or processors is generally known in the art.

It is generally known in the art to subdivide functional aspects of process 102 into multiple threads 106, 108 and 1 10. As used herein, “thread” refers to a portion of the functional processing of the multi-threaded process 102 designed and operable in accordance with multi-threaded aspects and features of the underlying computing system. For example, multi-threaded process 102 is shown in FIG. 1 as comprising three threads 106, 108 and 110. The three cooperating threads exchange information with one another as required via communication path 150. For example, the first thread 106 may be responsible for most user interaction while other threads may be responsible for other I/O and computational processing as required for the particular functions to be performed by multi-threaded process 102. Each thread 106, 108 and 110 includes thread processing elements, 107, 109 and 111, respectively, to perform its intended functional processing. Those of ordinary skill in the art will recognize that any number of threads may be designed in multi-threaded process 102 depending upon the functional requirements of its intended application.

In accordance with features and aspects hereof, each thread may be enhanced to invoke thread monitoring. Those of ordinary skill in the art will recognize that any number of such threads may incorporate the thread monitoring feature while any number of other threads may choose not to invoke the thread monitoring features and aspects hereof. As depicted in FIG. 1, all three threads (106, 108 and 110) of process 102 invoke thread monitoring features hereof but it is not necessary that every thread of a multi-threaded process need invoke the thread monitoring features and aspects hereof.

Each thread desiring to utilize thread monitoring features and aspects hereof includes invocation of a register thread method signifying its intent to be monitored in accordance with features and aspects hereof. For example, thread 106 includes register method invocation 114, thread 108 includes register method invocation 118, and thread 110 includes register method invocation 122. As it is generally known in the art, some threads of a process may be permanent in that they exist and operate in some manner throughout the lifetime of the corresponding process. Further, some threads may be transient in nature operable only to perform a certain limited function and then are destroyed or otherwise cease to operate or even exist in the process. Preferably, such transient threads may include invocation of an unregister method to signal its desire to be removed from further monitoring. The transient thread may then terminate in accordance with its intended design features. Thread 110 is intended as an example of such a transient thread that invokes unregister method 126 when its processing is completed. In addition, any thread may invoke a stop monitoring method to terminate further thread monitoring within the corresponding process. For example, thread 106 may invoke stop monitoring method 116, thread 108 may invoke stop monitoring method 120 and thread 110 may invoke stop monitoring method 124. Invocation of such a stop monitoring method may be useful where, for example, one or more threads may enter a dormant or non-responsive state by design. In such a case, the dormant threads may unregister to stop further monitoring of that thread or may stop all further monitoring so as to eliminate the possibility of undesired error conditions being reported for a thread that is non-responsive by design.

One of the multiple threads in process 102 may be designated a main thread 106. A monitor supervisor and associated structures 112 may be instantiated within the main thread 106 of process 102. The register method, unregister method and stop monitoring method all may communicate as required with the monitor supervisor 112 via the appropriate inter-thread or intra-thread communication paths (e.g., inter-thread communication path 150). Monitor supervisor 112 may maintain a list of all threads presently registered for monitoring. Such a list structure may be implemented in any suitable data structure desired by the monitor supervisor 112 including, for example a queue or linked list, a vector, etc. A register method invocation (e.g., 114, 118 or 122) therefore may represent a request from the invoking thread to be added to the monitoring list maintained by the monitor supervisor 112. An unregister method invocation (e.g., 126) may therefore signify a thread's desire to be removed from the list of monitored threads maintained by monitor supervisor 112.

The main thread 106 may be so designated in that it is often the first thread to start processing within process 102 and therefore the principle thread that responds to, or is reported on by, process monitor 104 regarding status of the entire process 102. Those of ordinary skill in the art will recognize that any thread may be designated as the main thread in that it instantiates the monitor supervisor and related structures. In essence, features and aspects hereof permit the main thread 106 to monitor threads 108 and 110. While, in effect, the process monitor 104 monitors the operability of the main thread 106.

If there is another function in the main thread (i.e., a portion of the intended process functionality), then that function may register with the monitor supervisor (also within the main thread) so that it can be polled. The periodic polling method invocations may provide periodic slices of processing time to permit the intended functional processing to be performed substantially concurrently with the monitor supervisor processing.

When the monitor supervisor 112 within that main thread 106 senses that thread 108 or thread 110 is no longer responding or appears to be hung in some manner, monitor supervisor 112 may be operable to restart the process 102 or optionally, to restart the inoperable thread so detected. Those of ordinary skill in the art will recognize that restarting a single thread within process 102 can entail a number of synchronization issues. Depending upon the nature of processing performed by the various threads within process 102, synchronization of such threads may be simple or difficult. By contrast, stopping and restarting the entire process 102 may be performed in accordance with well-known programming standards as dictated by the particular operating system and computing environment. In one aspect, the monitor supervisor may be operable in cooperation with the process monitor to perform the desired restart of the process containing the inoperable thread.

Those of ordinary skill in the art will readily recognize that FIG. 1 is intended merely as exemplary of one beneficial application of thread monitoring features and aspects hereof. In particular, computing system 100 may represent any number of computing systems or processors. Multi-threaded process 102 may be operable within a single computing system or distributed in accordance with well-known distributed programming techniques over a plurality of computing systems or processors. Any number of threads may be designed and operable within multi-threaded process 102. The threads may include any number of permanent threads and any number of transient threads. Further, any number of such threads may choose to enable monitoring of its thread by the monitor supervisor. Further, as noted above, the monitor supervisor may be instantiated and operable within any of the existing threads. In the best presently known mode of practicing features and aspects hereof, the monitor supervisor and related structures may be instantiated and operable within the main thread 106 of process 102 (e.g., the thread monitored by a process monitor 104). In addition, the monitor supervisor may be instantiated in an additional thread (not shown) spawned substantially exclusively for the purpose of instantiating the monitor supervisor and largely devoid of any particular functional thread processing. Those of ordinary skill in the art will recognize numerous equivalent designs, topologies, and functional decompositions for computing systems in which multi-threaded processes are operable with thread monitoring features in accordance with features and aspects hereof.

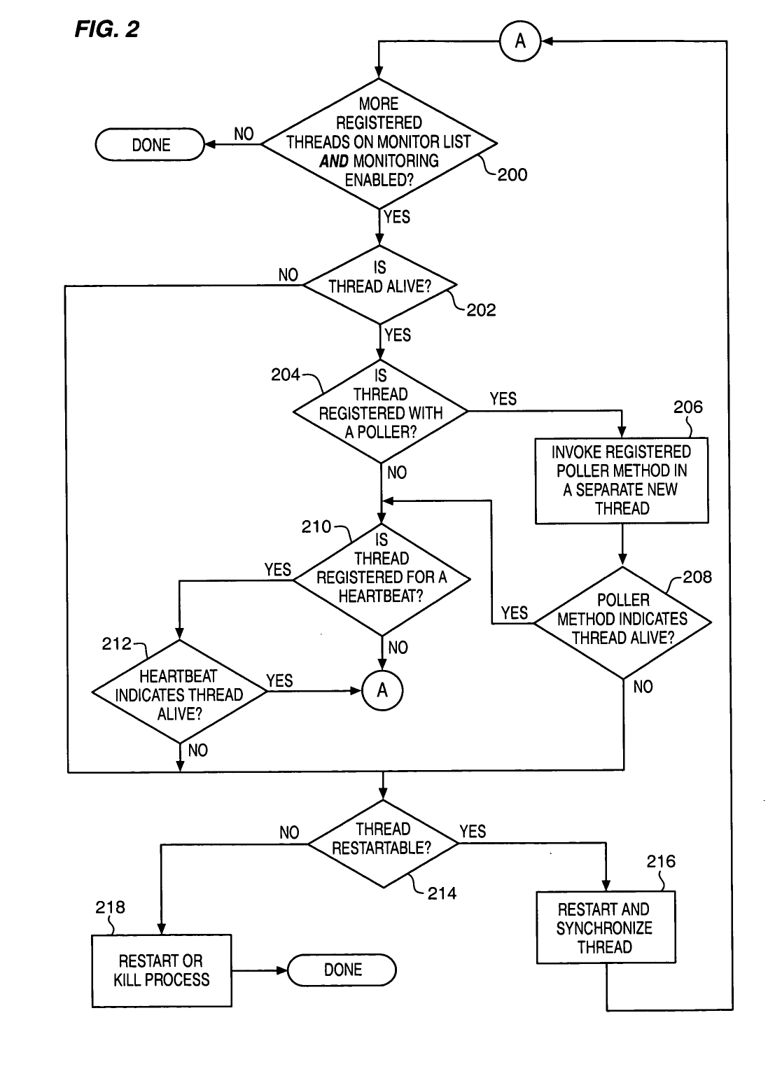

FIG. 2 is a flowchart describing operation of the monitor supervisor method associated with thread monitoring features and aspects hereof. As noted above, the monitor supervisor method may be instantiated and operable within any thread of the multi-threaded process and most preferably is instantiated and operable within the main thread of the multi-threaded process. In addition, processing of the monitor supervisor is preferably continuous and substantially concurrent with other functional processing within the thread that instantiated to the monitor supervisor. Preferably, the main thread may invoke only processing of the monitor supervisor (and any desired thread heartbeat method invocations) so as to reduce the complexity of integrating the monitor supervisor processing with functional processing of the multi-threaded process. In addition, processing of the monitor supervisor is preferably continuous and substantially concurrent with other functional processing within the thread (if any) that instantiated to the monitor supervisor. Any of several well-known thread programming techniques may be utilized to periodically perform thread monitor processing while continuing to provide functional operation of the thread in which to monitor supervisor is instantiated. FIG. 2 represents only of the monitor supervisor processing and does not depict a design for integrating such monitor supervisor processing with other functional processing of the same thread.

The method of FIG. 2 is intended to be periodically operable to verify operability of all threads that have requested such monitoring service. Preferably, the monitor supervisor is periodically started to verify proper operation of each thread presently registered for the monitoring service. On each such periodic operation of the supervisor, each thread so registered is checked to be certain it is presently operating properly. As noted above, the monitor supervisor may maintain a list of all presently registered threads desirous of monitoring. Element 200 is first operable to determine whether additional threads remain in the monitor list to be monitored and whether monitoring is presently enabled or disabled. If no further threads remain on the monitor list to be monitored at present, or if monitoring by the supervisor is presently disabled, operation of this periodic invocation of the monitor supervisor is completed to be invoked again at a later time. If element 200 determines that additional threads are registered on the monitoring list and determines that monitoring is presently enabled, elements 202 through 216 are operable to monitor the next registered thread on the monitoring list.

Element 202 first tests whether the thread is presently alive. Many computing environments including, for example, the Java programming environment, include a system method associated with a thread object to determine whether the associated thread is presently alive. Often such a method is named or referred to as: “IsAlive”. Element 202 therefore invokes the IsAlive method for the thread presently being monitored. If the IsAlive method invocation returns a status indicating that the thread is no longer alive, processing continues and element 214 as discussed further herein below. If element 202 determines that the monitored thread presently indicates that it is alive, elements 204 and 210 next determine whether additional monitoring features have been requested by the registered thread. As noted above and as discussed further herein below, a thread may register for HeartBeat monitoring or Polling monitoring as well as simple registration for “IsAlive” monitoring. Specifically, element 204 determines whether the registered thread presently being monitored requested registration with a Polling method provided in the registration request. If so, element 206 is operable to invoke the registered Polling method associated with the registered thread. The registered thread's Polling method is provided as programmed instructions within the registered thread to further evaluate the status of the monitored thread. Any appropriate function may be performed within the Polling method to more accurately determine the present status of the registered thread. Preferably, the provided polling method adheres to coding standards such that a response will be supplied to the monitor supervisor within a predetermined period of time to permit the monitor supervisor to continue evaluating the present status of other registered threads. In addition, as indicated in element 206, the Polling method provided by the registered thread may be invoked in a separate, new thread spawned by the monitor supervisor. Spawning a new thread to process the polling method of the registered thread allows the monitor supervisor to guarantee that the Polling method will either complete in a predetermined amount of time or may allow the monitor supervisor to determine that the registered thread is inoperable because the polling method fails to return within a predetermined time. In either case, element 208 is next operable to determine whether the Polling method indicates that the associated thread is still alive and properly operable. If so, processing continues at label “A” (element 200) to continue processing additional registered threads on the monitor list. If element 208 determines that the polled, registered thread is not properly operable, processing continues at element 214 as discussed further herein below.

If element 204 determines that the registered thread presently being monitored did not register with a polling method supplied, element 210 is operable to determine whether the registered thread included parameters to register for HeartBeat monitoring. As generally known in the art, a “HeartBeat” refers to a periodic message sent from a monitored thread to indicate its continued proper operation. Failure to receive such a HeartBeat message over some predetermined period of time may be an indication that the thread has hung or become otherwise inoperable. If element 210 determines that the registered process has not requested HeartBeat monitoring in its registration invocation, processing continues at label “A” (element 200) to continue processing other registered threads within the monitor supervisor. If element 210 determines that the registered thread presently being monitored requested registration with HeartBeat parameters, element 212 is operable to determine whether the thread is properly operable based on the time of receipt of the last HeartBeat message from the registered thread. As discussed further herein below, a registered thread requesting HeartBeat monitoring periodically transmits a HeartBeat message to indicate its continued proper operation. Element 212 therefore determines whether the last received HeartBeat message was received within an acceptable period of time to consider the thread to be properly operating. If element 212 determines that the thread appears to be properly operating, processing continues at label “A” (element 200) to process additional registered threads on the monitor list. If element 212 determines that the most recently received HeartBeat (if any) was not received within an appropriate period of time, processing continues with element 214 as discussed further herein below presuming that the thread has become hung or otherwise inoperable.

If elements 202, 212, or 208 determine that a thread appears to be inoperable or otherwise hung, element 214 determines whether the apparently hung thread may be independently restarted. If not, element 218 is operable to restart or terminate the entire process that includes the apparently inoperable thread. Programming techniques to terminate and/or restart such a process are well known to those of ordinary skill in the art. Processing of the supervisor then terminates with respect to the present list of monitored threads awaiting restart of the process and registration of threads to be monitored anew. If element 214 determines that the apparently inoperable thread may be independently restarted, element 216 is operable to restart the hung or inoperable thread and perform appropriate processing to synchronize the restarted thread with other threads associated with the same process. As noted above, processing to effectuate such synchronization among a plurality of threads when a single thread is restarted is unique to each particular application and process. Requirements for such synchronization in a particular application will be readily apparent to those of ordinary skill in the art. Where individual thread restart and synchronization is not available due to computing environments or operating system constraints, or due to constraints of the particular multi-threaded process application, the testing of element 214 may be optional and the processing of element 218 may be consistently invoked where any thread is determined to be hung or otherwise inoperable.

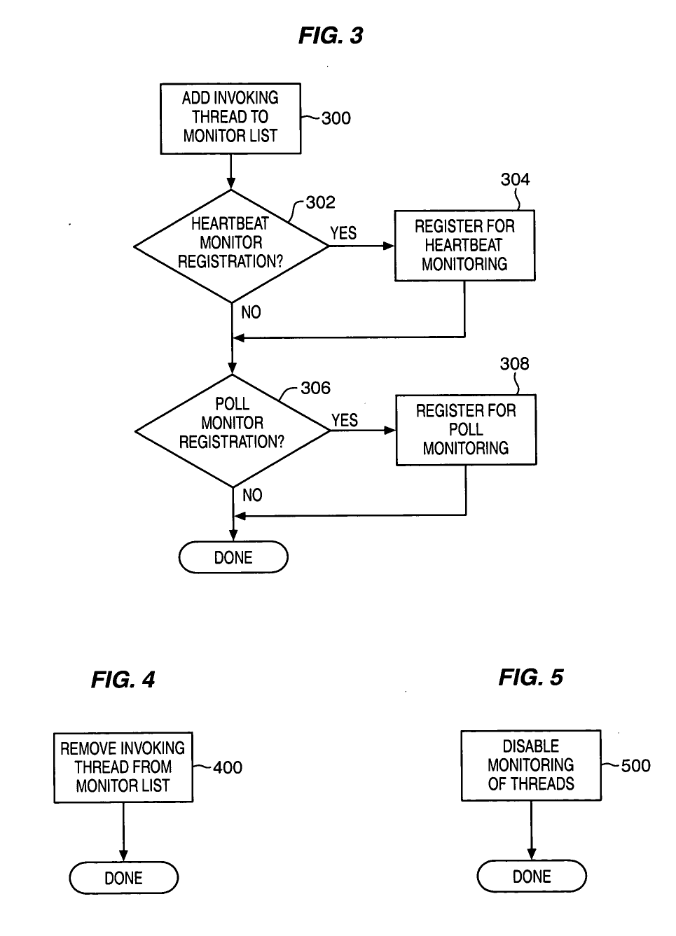

FIGS. 3 through 8 are flowcharts describing additional details of operations performed within the monitor supervisor and/or performed by threads utilizing the monitoring features and aspects hereof. FIG. 3 is a flowchart describing processing of the monitor supervisor responsive to invocation of a register method by a thread desiring monitoring of its processing. In an exemplary embodiment of features and aspects hereof, a thread may request registration for simple “IsAlive” processing and, in addition, may include a request to monitor its status using either a Polling method or a HeartBeat method. In computing system environments which do not provide support for the “IsAlive” feature, the HeartBeat and Polling methods may be the only types of monitoring available. Such matters of design choice are well known to those of ordinary skill in the art.

Element 300 is operable to add the requesting thread to the list of threads to be monitored by the monitor supervisor. As above, such a list may be maintained in any suitable data structure such as linked lists, queues, vectors, etc. Design choices for creation and maintenance of a list are readily apparent to those of ordinary skill in the art. By virtue of being added to the monitor list, the requesting thread will be monitored using at least the “IsAlive” monitoring technique (if available in the computing environment). In other words, in one exemplary embodiment, all threads invoking any register method will be registered for “IsAlive” monitoring processing. Element 302 then determines whether the parameters of the register request indicate that the thread desires HeartBeat monitoring. If so, element 304 annotates the thread registration information to indicate the frequency of expected HeartBeat signals and other parameters associated with HeartBeat monitoring. In both cases, element 306 next determines whether the requesting thread has requested Polling monitoring (supplying a polling method as part of the registration request). If so, element 308 then annotates the monitoring registration information for the thread to indicate the Polling method to be used and other parameters of Polling monitoring to be performed. In both cases, the method completes having thus registered the requesting thread for any combination of IsAlive, HeartBeat and Polling monitoring by the monitor supervisor.

Those of ordinary skill in the art will recognize a variety of similar processing techniques whereby other types of polling options may be utilized or other combinations of polling options may be provided. For example, IsAlive monitoring may be optional and not provided by default. Or, for example, other combinations allowing both HeartBeat and Polling monitoring methods to be requested may be provided by similar processing readily apparent to those of ordinary skill in the art.

FIG. 4 represents processing of an unregister method invocation whereby a thread previously registered for monitoring requests removal from further monitoring. For example, such an operation may be desirable where the thread is a transient thread rather than a permanent thread. A transient thread may be destroyed or dormant upon completion of its intended processing. Preferably, such a transient thread would be removed from the monitoring list so as to not generate unintended error conditions in the monitor supervisor. Element 400 therefore represents processing by the monitor supervisor to remove a requesting thread from the monitor list in response to invocation of the unregister method by the previously registered, monitored thread. Details of the list or vector processing appropriate to remove an entry previously added to the monitor list will be readily apparent to those of ordinary skill in the art.

FIG. 5 is a flowchart of a stop monitoring method invocation. In like manner, a monitored thread may invoke the stop monitoring method to request that the monitor supervisor discontinue monitoring operation for all threads. Certain processing within the threads of a multi-threaded process may be computationally intensive or I/O intensive to such a degree that monitoring will not succeed during such periods of intensive operations. Element 500 therefore represents processing by the supervisor monitor to disable further processing to monitor threads of a multi-threaded process. As noted, in one aspect, disabling or stopping further monitoring may, as shown in FIG. 2 above, disable monitoring for all threads of the multi-threaded process.

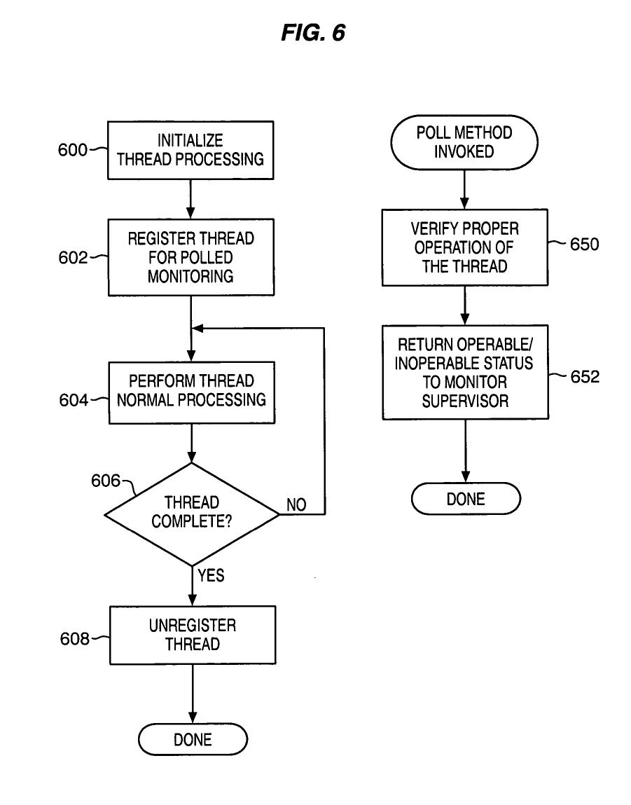

FIG. 6 is a flowchart representing processing within a thread requesting monitoring by the monitor supervisor. Element 600 is first operable to initialize processing within the thread including any initialization required for the intended functional processing of the thread. Element 602 is then operable to register the thread for Polling monitoring. As noted above, in one aspect hereof, invocation of any register method, including the Polling register method, implies registration for “IsAlive” processing as well. The Polling registration method therefore registers the requesting thread for both “IsAlive” monitoring as well as Polled monitoring. As noted above, the Polled registration supplies a parameter referencing a Poll method provided by the requesting thread to be invoked by the monitor supervisor to evaluate the present state of operability of the requesting thread. Element 604 then performs desired functional processing by the requesting thread. Element 606 then determines whether the intended functional processing of the thread has completed. If processing is completed, element 608 is operable to unregister the thread to discontinue further monitoring of the completed thread. If thread processing is not complete, processing continues looping through element 604 until the normal, intended functional processing of the thread has completed.

During the iterative processing of elements 604 and 606, the monitor supervisor may periodically invoke the Polling method provided by the requesting thread by operation of element 602. Elements 650 and 652 represent the processing of the Poll method associated with the thread as periodically invoked by the monitor supervisor. As noted, a reference to the Poll method is provided in the register invocation discussed above with respect to element 602. Having so registered for Polling monitoring, the monitor supervisor will periodically invoke the supplied Poll method to determine the present state of operability of the associated thread. In particular, element 650 performs any desired processing to verify proper operation of the associated thread. Such processing may include any processing appropriate to determine the present state of operability of the thread including, for example, verifying the state or values of private or public data structures within the thread, or any other processing useful to determine the present state of the associated to read. Those of ordinary skill in the art will recognize that the particular processing of element 650 is unique to each thread of each particular application of the features and aspects hereof. Such design choices will be readily apparent to those of ordinary skill on the art to determine appropriate status of the associated thread. Element 652 then returns a summary status indicating that the associated thread is properly operable or presently inoperable. The return status is provided to the monitor supervisor which, in turn, determines appropriate measures to terminate or restart the thread or process when a thread is determined to be inoperable.

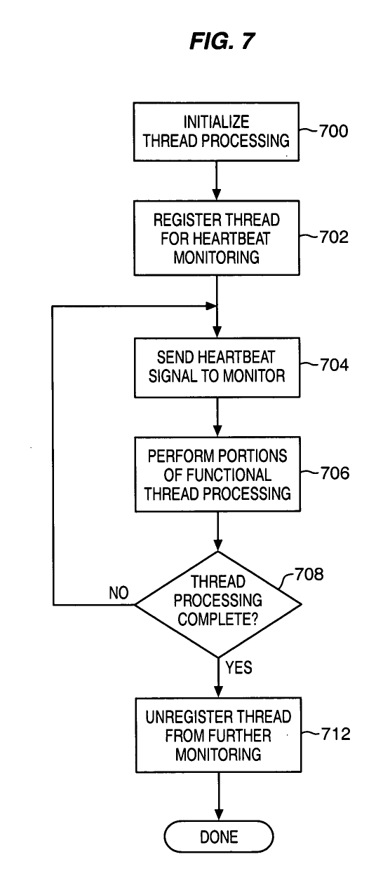

FIG. 7 is a flowchart describing exemplary operation of a thread utilizing HeartBeat monitoring features and aspects hereof. Element 700 is first operable to initialize functional processing of the thread for its intended application. As above with respect to element 600 of FIG. 6, element 700 represents any appropriate processing to prepare the thread for its intended functional operation. Element 702 then invokes the register method of the monitor supervisor with parameters indicating that the HeartBeat monitoring is to be provided to monitor the health of the associated thread. As noted above, parameters associated with the HeartBeat registration method invocation may identify an expected frequency of HeartBeats to be provided by the invoking thread and parameters indicating the maximum number or duration for missing HeartBeats before declaring the associated thread inoperable or hung.

Elements 704 through 708 are then iteratively operable to perform portions of the intended functional processing of the thread interspersed with periodic HeartBeat signals generated and transmitted to the monitor supervisor. Element 704 generates a HeartBeat signal and transmits the HeartBeat signal to the monitor supervisor. As noted above, any of several well-known programming techniques may be utilized to generate and transmit such a signal or message from the invoking thread being monitored to another thread instantiating the monitor supervisor. Element 706 then performs some portion of the functional processing for the thread's intended application. Element 708 then determines whether the thread's functional processing has completed. If not, processing continues looping back to elements 704 and 706 to generate and transmit a next HeartBeat signal to the monitor supervisor and to perform additional portions of the intended functional processing of the thread. When element 708 determines that the intended functional processing of the thread has completed, element 712 invokes the unregister method to terminate further monitoring of the associated thread. As noted, the unregister method may be useful where a particular thread is transient in nature and not permanently operable throughout the lifetime of the multi-threaded process. The transient thread may preferably unregister before terminating so that the monitor supervisor will not sense the properly terminated transient thread as a hung or inoperable thread.

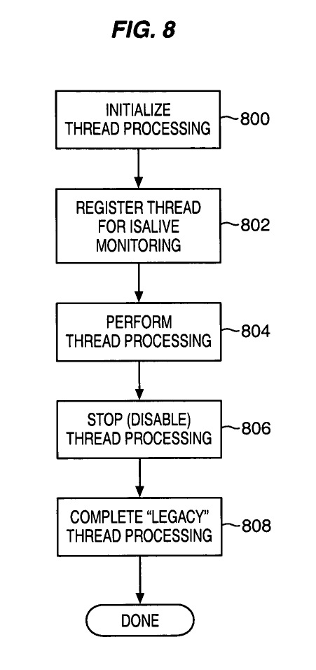

FIG. 8 is a flowchart describing exemplary processing of another thread for which “IsAlive” monitoring is requested. In the exemplary processing of FIG. 8, monitoring is enabled for a first portion of the thread's processing and disabled during a subsequent portion of processing for the thread or entire process. Such a technique may be useful, for example, where portions of a thread or an entire process are not easily adapted to use the monitoring features and aspects hereof (i.e., so called legacy portions of a thread or process). During that period of such legacy processing within the thread or process, monitoring features and aspects hereof may be disabled to avoid unintended error conditions. Element 800 initializes processing for the thread analogous to that discussed above with respect to elements 600 and 700 of figures six and seven, respectively. Element 802 then registers the thread for “IsAlive” monitoring by the monitor supervisor. As noted above, in one aspect hereof, registering without parameters indicating HeartBeat or Polling methods are to be utilized may default to monitoring for “IsAlive” features exclusively. Element 804 then represents thread processing in which thread monitoring may be performed using the requested “IsAlive” monitoring techniques. Element 806 then invokes the stop monitoring method to cease monitoring of all threads of the process. In preparation for further thread processing not readily adapted for thread monitoring, the stop monitoring method invocation ceases further operation of the monitor supervisor to monitor this or any threads within the multi-threaded process. As noted, as a matter of design choice, the stop monitoring method may selectively disable monitoring of only the requesting thread or may disable monitoring of all threads in the multi-threaded process. Element 808 then represents further functional processing within the requesting thread not easily adapted to permit monitoring of the thread's status.

Those of ordinary skill in the art will recognize a wide variety of equivalent methods and associated data structures for providing the thread monitoring features and aspects hereof. The flowcharts of FIGS. 2 through 8 are therefore intended merely as exemplary of one possible implementation of such features. In one possible embodiment of such thread monitoring features, the thread monitoring class may be instantiated as an object in a main thread of the multi-threaded process. The class may include a number of public functions useful for the main thread or other threads to register, unregister, signal HeartBeats, and disable monitoring as follows:
registerThread(threadID)
registerThread(threadID, poller)
registerHBThread(threadID, heartbeatlnterval)
registerHBThread(threadID, heartbeatlnterval, poller)
   Each thread that would like to be monitored invokes one of the above register methods from within the thread's “run( )” method to register itself with the Thread Monitor class monitor supervisor (instantiated in the same or another thread). The requesting thread passes its handle/reference as “threadID” as a parameter when invoking the registerThread method. Such a registration invocation is sufficient to request simple “IsAlive” monitoring of the thread by the monitor supervisor. Threads that also want to invoke the heartbeat style monitoring invoke the registerHBThread method with heartbeat parameters. The supplied heartbeatlnterval parameter specifies a period of time during which the supervisor should expect to receive heartbeat signals from the requesting thread. In invoking either registerThread or registerHBThread, the requesting thread may also supply a “poller” method to be invoked by the monitor supervisor. The poller method, created by the thread designer, performs any suitable tests to determine whether the requesting thread is properly functioning. The particular tests are as appropriate to the particular features of the requesting thread. The monitor supervisor saves all the registration information for each requesting thread and periodically verifies the proper operation of each registered thread.
unRegisterThread(threadID)
   A transient thread, for example, may invoke this method to stop monitoring of the requesting thread. Since a transient thread may cease to exist, continued monitoring may generate false errors from the monitor supervisor.
threadHB( )
   This method is invoked by the requesting thread to be monitored with a heartbeat signal. The method generates a heartbeat signal/message for the monitor supervisor to signal continued health and operability of the thread being monitored.
stopThreadMonitor( )
   This method is invoked by any thread to stop monitoring of all threads by the monitor supervisor. This method may preferably be invoked prior to termination of the multi-threaded process. In addition, the process may be invoked where certain processing of the multi-threaded process may not be properly adapted for thread monitoring (i.e., where legacy processing features of one or more threads may not be readily adapted for monitoring).

As an example, a typical thread may use the monitoring features as follows (note that the code segment is not intended as fully operational code in any particular programming language but rather is Java-like pseudo-code intended to suggest a typical design approach to those of ordinary skill in the art):

run()
{

// The thread uses heartbeat monitoring and expects to signal
// a heartbeat at least every 30 seconds. The thread also provides
// a polling method (“mypoller”) to be invoked by the monitor
// supervisor periodically.
ThreadMonitor.registerHBThread(this, 30, mypoller)
while(someCondition)
{

ThreadMonitor.threadHB() // signal a heartbeat
do some processing . . .
ThreadMonitor.threadHB() // signal another heartbeat
sleep(sometime)
ThreadMonitor.threadHB() // signal another heartbeat
. . .

}

}
mypoller()
{

(optionally) perform other functional processing for the thread . . .
test to verify proper operation of above thread . . .
if (operating properly)

return OPERABLE_STATUS

else

return INOPERABLE_STATUS

}

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. In a computing system providing multi-threaded programming support, a system comprising:
a thread monitor class providing thread monitoring services to threads of a multi-threaded process, the thread monitor class including:
a thread registration method to register a thread for monitoring by the class; and
a thread monitoring supervisor to monitor all threads registered for monitoring operation of threads that invoke the thread registration method.

2. The system of claim 1 wherein the thread monitor class further includes:
a thread un-registration method to remove a prior registration of a thread for monitoring by the class.

3. The system of claim 1 wherein the thread monitor class further includes:
a stop thread monitoring method to terminate monitoring of all threads registered for monitoring by the class.

4. The system of claim 1 wherein the thread monitor class further includes:
a thread HeartBeat method to signal a HeartBeat from a thread registered for monitoring by the class.

5. The system of claim 1 wherein the thread registration method comprises:
a thread alive check registration method invoked by a thread to register for monitoring by the class wherein the monitoring comprises periodically verifying that the invoking thread is still alive.

6. The system of claim 1 wherein the thread registration method comprises:
a thread poll registration method invoked by a thread to register for monitoring by the class wherein the monitoring comprises periodically verifying that the invoking thread is properly operating by invoking a poll method derived from the thread poll registration invocation.

7. The system of claim 1 wherein the thread registration method comprises:
a thread HeartBeat registration method invoked by a thread to register for monitoring by the class wherein the monitoring comprises periodically verifying that the invoking thread is still alive based on receipt of periodic HeartBeat method invocations from the thread invoking the thread HeartBeat registration method.

8. The system of claim 1 wherein the thread monitoring supervisor is instantiated within a main thread of a multi-threaded program.

9. The system of claim 1 wherein the thread monitoring supervisor is further operable to restart an inoperable thread.

10. The system of claim 1 wherein the thread monitoring supervisor is further operable to restart the process that includes an inoperable thread.

11. A method for monitoring operability of multiple threads of a computer process comprising the steps of:
instantiating a thread monitoring supervisor in a thread of a multi-threaded process;
registering an additional thread of the multi-threaded process for monitoring of its operation by the thread monitoring supervisor; and
monitoring the operability of the additional thread by operation of the thread monitoring supervisor.

12. The method of claim 11
wherein the step of registering further comprises registering the additional thread as a HeartBeat thread for monitoring according to HeartBeat signals,
wherein said additional thread is operable to periodically communicate a HeartBeat signal with the monitoring supervisor, and
wherein the step of monitoring further comprises detecting periodic receipt of HeartBeat signals to monitor operability of said additional thread.

13. The method of claim 11
wherein the step of monitoring further comprises determining whether said additional thread is still alive to monitor operability of said additional thread.

14. The method of claim 11
wherein the step of registering further comprises registering the additional thread as a polling thread associated with a poll function to indicate the operability status of the additional thread, and
wherein the step of monitoring further comprises periodically invoking the poll function associated with the additional thread to monitor operability of the additional thread.

15. The method of claim 11 wherein the step of instantiating further comprises instantiating the thread monitoring supervisor in a main thread of the multi-threaded process.

16. The method of claim 11 further comprising restarting an inoperable thread.

17. The method of claim 11 further comprising restarting a process that includes an inoperable thread.
